(19) United States
(12) Patent Application Publication
(10) Pub. No.: US 2005/0166455 A1
(43) Pub. Date: Aug. 4, 2005

(54) Plant pot

(76) Inventor: Junji Nishida, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/767,169

(22) Filed: Jan. 30, 2004

(51) Int. Cl. A01G 9/02

(52) U.S. Cl. 47/79

(57) ABSTRACT

A plant pot comprises a bottom, a drainage hole provided at the bottom in a protruding manner, and a water storage portion formed at the inside of the bottom.

### FIELD OF THE INVENTION

The present invention relates to improvements of plant pots.

### BACKGROUND OF THE INVENTION

Plant pots used for planting ornamental plant flowers, for example, or for raising seedlings, are generally formed in such a manner that brown ware or synthetic resin materials are formed into a cylindrical shape with the bottom by injection molding, and the bottom is provided with a perforated hole for drainage in a penetrating manner.

In a case where such plant pots are used, after the perforated hole for drainage provided at the bottom is blocked with a net or pebbles in a porous state, potting soil is placed into the plant pot and ornamental plant flowers are vegetated and raised with the potting soil.

In the above-described formed plant pot, water during sprinkling is easily drained. Therefore, water supply should be frequently carried out in the summer, or during a dry season. This presents a drawback in which management of plants such as ornamental plant flowers is troublesome.

Then, blockage of the drainage hole may be considered. However, the drainage hole functions as a permeable hole as well. As such, there is a drawback in that blockage can not be carried out since root rot tends to occur.

### SUMMARY OF THE INVENTION

Then, the present invention has been proposed in consideration of the above-described drawbacks, and the purpose of the invention is to provide a plant pot in which the water supply interval can be long even in the summer without causing root rot, and management of plants can be carried out handily.

The plant pot according to the present invention for achieving the above-described object is formed in a cylindrical shape with the bottom and the upper part thereof is open. The bottom is provided with a drainage hole in a penetrating manner, and a water storage portion is provided at the inside surface of the bottom.

Additionally, the plant pot of the present invention has a drainage hole formed at the central part of the bottom, and a partition wall is installed inside the plant pot at the circumference of the drainage hole. Water storage portions are formed between the corresponding partition wall and the inner circumferential surface of the side wall of the plant pot.

### BRIEF DESCRIPTION OF THE DRAWINGS

FIG. 1 is a perspective view of the plant pot according to the present invention.

FIG. 2 is a plan view of the plant pot according to the present invention.

FIG. 3 is a bottom view of the plant pot according to the present invention.

FIG. 4 is a longitudinal sectional view of the plant pot according to the present invention.

FIG. 5 is a longitudinal sectional view of a state of use of the plant pot according to the present invention.

FIG. 6 is a longitudinal sectional view of a state in which the plant pots according to the present invention are stacked.

### DESCRIPTION OF THE PREFERRED EMBODIMENT

An embodiment of the plant pot according to the present invention will be described with reference to the drawings.

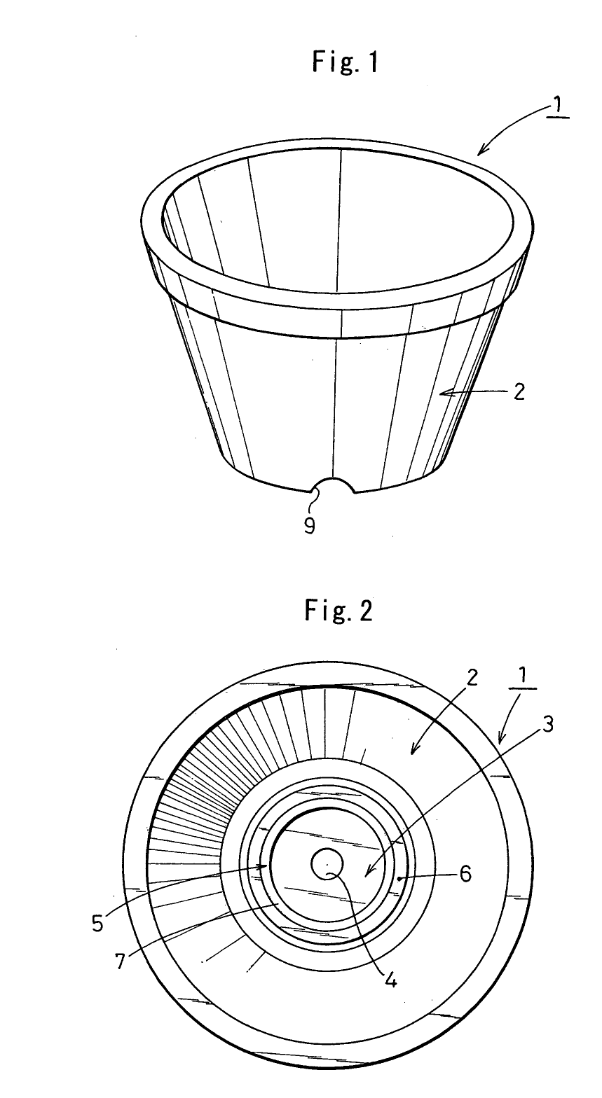

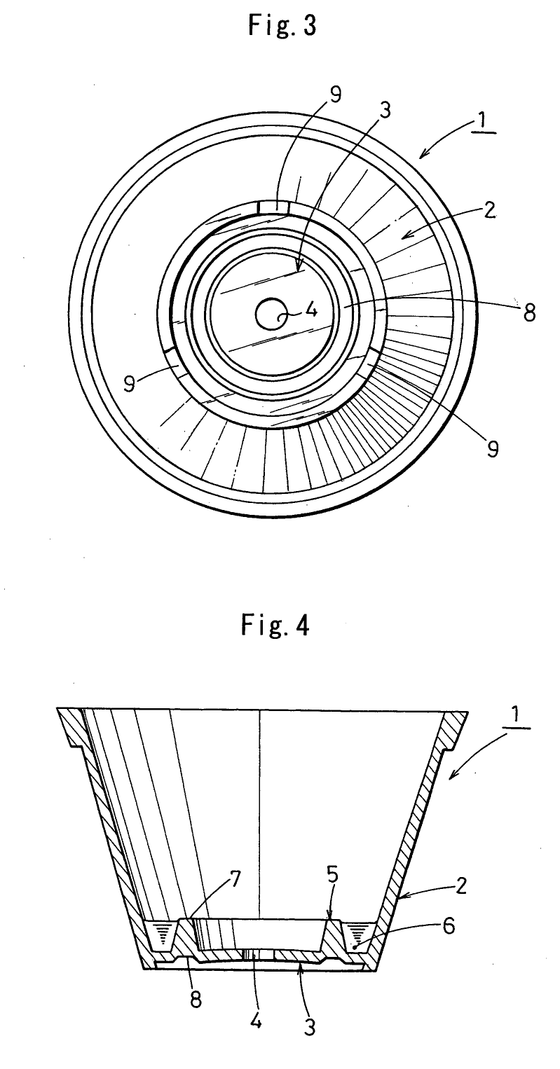

FIG. 1 is a perspective view of the plant pot of the present invention, FIG. 2 is a plan view of the plant pot, FIG. 3 is a bottom view of the plant pot, FIG. 4 is a longitudinal sectional view of the plant pot, and numeral 1 in the drawings generally denotes the plant pot.

The plant pot 1 is formed in a cylindrical shape with a side wall 2 having a tapered shape in which the upper part opens outwardly narrowing downwardly, by injection molding a synthetic resin material. The bottom wall 3 is formed in a plate shape, and is formed slightly above the bottom end of the side wall 2. A drainage hole 4 is provided at the central part thereof in a penetrating manner (i.e., a through-hole). The drainage hole 4 not only drains surplus water but functions to support breathing (ventilation) of the potting soil to be fed into the plant pot 1 or plant roots.

Additionally, at the substantially intermediate position on the upper surface of the bottom wall 3 between the drainage hole 4 and the inner circumferential surface of the side wall 2, a circular partition wall 5 is integrated with the bottom 3. Thus, a water storage portion 6 is formed between the corresponding partition wall 5 and the inner circumferential wall of the side wall 2 (Refer to FIG. 2 and FIG. 4.). In addition, as clearly shown in the sectional view of FIG. 4, the partition wall 5 also forms a central drainage bowl portion having the drainage hole 4 located at the bottom thereof.

As shown in FIG. 4, the bottom 3 surrounded by the circular partition wall 5 in which the drainage hole 4 is formed (i.e., the bottom of the drainage bowl portion)has a gradual sectional circular arc i.e., convex shape so that the drainage hole 4 is located at the apex. On the lower surface of the bottom wall 3 just below the circular partition wall 5, a hollow (groove) 8 is circularly formed so as to fit onto the upper end part 7 of the partition wall 5. As shown in FIG. 4, the groove 8 is formed in the outer surface of bottom wall 3 so as to be located opposite the partition wall 5. Further, at the lower end part of the side wall 2 formed in a tapered shape in which the upper part opens outwardly narrowing downwardly, semicircular hollows groove 9 are formed for draining water drained from the drainage hole 4 or for allowing circulation of air for breathing of plant roots.

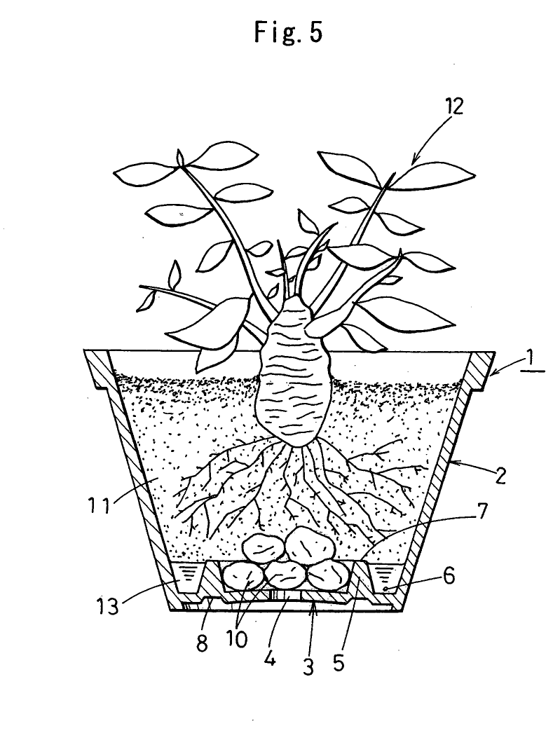

As shown in FIG. 5, in the above-described formed plant pot 1, the drainage hole 4 provided at the center of the bottom wall 3 (i.e., in the drainage bowl portion) in a penetrating manner might be blocked with pebbles 10, or the like. In this case, the partition wall 5 is formed at the circumference of the drainage hole 4, whereby the quantity of pebbles 10 can be reduced in comparison with the conventional pot bottom 3 which is bedded over with pebbles.

Next, potting soil 11 is fed into the plant pot 1, and an ornamental plant 12 is planted and raised therein. During raising of the plant, fertilizer application and water supply are carried out, and the surplus is drained out from the drainage hole 4. On the other hand, at the water storage portion 6 formed between the partition wall 5 and the inner circumferential surface of the side wall 2, water 13 in which fertilizer, etc., is dissolved is stored.

Therefore, the potting soil 11 is moistened with the water 13 containing fertilizer being stored in the water storage portion 6, whereby the ornamental plant 12 is prevented from being run dry even when water supply is omitted. Thus, management of the ornamental plant 12 is facilitated by making the interval of water supply long.

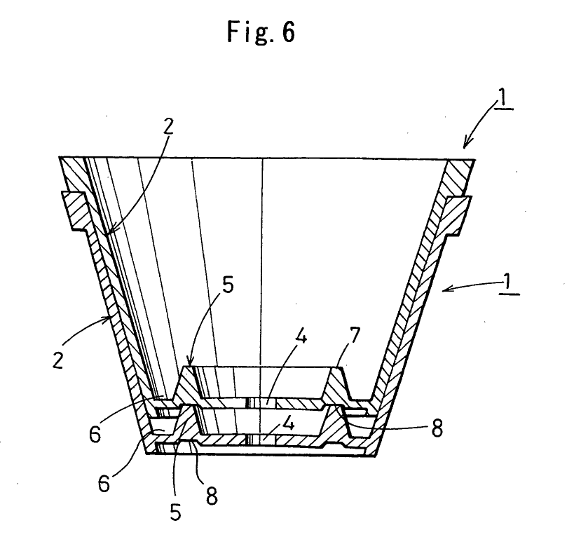

Additionally, as shown in FIG. 6, when transporting or housing the plant pot 1 of the present invention, the plant pots are stacked by making the upper end part 7 of the partition wall 5 align with the circular hollow groove 8 formed at the lower surface of the bottom 5. Thus, not only transport or housing of the plant pots is carried out compactly in a stable manner without consuming space, but also removal of the plant pots can easily be carried out without remaining stacked to each other.

Further, in the above-described embodiment, the plant pot 1 is formed of a synthetic resin material. However, it is not limited thereto, and the plant pot 1 may be formed of brown ware or another material.

Additionally, in the above-described embodiment, the drainage hole 4 is formed at the center of the bottom. However, a plurality of drainage holes 4 may be provided in a penetrating manner. Further, the water storage portion can be formed at the center of the bottom and the plurality of drainage holes may be formed at the circumference thereof.

As described above, in the plant pot according to the present invention, the drainage hole is provided in a penetrating manner at the bottom of the plant pot which is formed in a cylindrical shape with the bottom and has an upper part which is open. The water storage portion is formed at the inside of the bottom, so that a portion of water supplied into the plant pot is stored at the water storage portion. Advantageous effects can be brought about such that the water supply interval can be long even in the summer, or a dry season, saving trouble, whereby management of plants can be carried out handily.

Additionally, since the drainage hole is not sealed hermetically, permeability from the drainage hole can be acquired, whereby advantageous effects can be brought about such that root rot can be prevented and favorable conditions of plants can be maintained over a long period of time.

1-8. (canceled)

9. A plant pot comprising:
a sidewall;
a bottom wall attached to said sidewall, said bottom wall having a drainage through-hole; and
a partition wall extending upwards from an inner surface of said bottom wall, said partition wall being shaped and arranged to form a water storage portion for holding water between an outer surface of said partition wall and an inner surface of said sidewall, and to form a drainage bowl portion having said drainage through-hole at a bottom thereof.

10. The plant pot of claim 9, wherein said partition wall has a circular configuration and surrounds said drainage through-hole.

11. The plant pot of claim 9, wherein said partition wall integrally extends from said bottom wall such that said bottom wall and said partition wall have a one-piece construction.

12. The plant pot of claim 9, wherein said drainage through-hole is located at a center of said bottom wall, said partition wall being formed around said central drainage through-hole so as to form a central drainage bowl portion.

13. The plant pot of claim 12, wherein said water storage portion is formed around an entire periphery of said partition wall.

14. The plant pot of claim 12, wherein said sidewall has grooves formed in an end thereof closest to said bottom wall, said grooves communicating with said drainage through-hole to allow drainage and ventilation along an outer surface of said bottom wall via said sidewall.

15. The plant pot of claim 9, wherein said sidewall has a tapered shape having a small-diameter end at said bottom wall.

16. The plant pot of claim 15, wherein said bottom wall has a groove formed in an outer surface thereof so as to be located opposite said partition wall.

17. The plant pot of claim 16, wherein said partition wall has a circular configuration, and said groove has a circular configuration corresponding to said partition wall.

18. The plant pot of claim 9, wherein said bottom wall has a convex shape, said drainage through-hole being located at an apex of said convex bottom wall.

19. The plant pot of claim 18, wherein said sidewall has grooves formed in an end thereof closest to said bottom wall, said grooves communicating with said drainage through-hole to allow drainage and ventilation along an outer surface of said bottom wall via said sidewall.

20. The plant pot of claim 9, wherein said sidewall has grooves formed in an end thereof closest to said bottom wall, said grooves communicating with said drainage through-hole to allow drainage and ventilation along an outer surface of said bottom wall via said sidewall.
